(19) United States
(12) Patent Application Publication
(10) Pub. No.: US 2024/0262560 A1
(43) Pub. Date: Aug. 8, 2024

(54) CONTAINER BASE WITH STRAPS AND DIAPHRAGM

(71) Applicant: AMCOR RIGID PACKAGING USA, LLC, Ann Arbor, MI (US)

(72) Inventors: Jeffery VAJEN, New Boston, MI (US); John SICILIANO, Dexter, MI (US); James STELZER, South Lyon, MI (US); Omkar DOLE, Kalamazoo, MI (US)

(21) Appl. No.: 18/570,243

(22) PCT Filed: Jun. 29, 2021
(86) PCT No.: PCT/US2021/039516

§ 371 Date: Dec. 14, 2023

(51) Int. Cl. B65D 1/02

(52) U.S. Cl. CPC B65D 1/0284

(57) ABSTRACT

A polymeric container including a base that moves inward toward the finish from an as-blown configuration to a post-fill, post vacuum configuration after the container has been filled and capped to generate a vacuum therein. In the as-blown configuration a diaphragm is linear in cross-section. In the post-fill, post-vacuum configuration the diaphragm is concave relative to an outer surface of the base. As the base moves inward from the as-blown configuration to the post-fill, post vacuum configuration, an angle of intersection between an outer standing surface and a heel decreases as vacuum in the container increases and a pushup portion moves inward towards a finish of the container.

### FIELD

The present disclosure relates to a container including a base with straps and a diaphragm, the base configured to absorb vacuum created within the container.

### BACKGROUND

This section provides background information related to the present disclosure which is not necessarily prior art.

As a result of environmental and other concerns, plastic containers, more specifically polyester and even more specifically polyethylene terephthalate (PET) containers are now being used more than ever to package numerous commodities previously supplied in glass containers. Manufacturers and fillers, as well as consumers, have recognized that PET containers are lightweight, inexpensive, recyclable and manufacturable in large quantities.

Blow-molded plastic containers have become commonplace in packaging numerous commodities. PET is a crystallizable polymer, meaning that it is available in an amorphous form or a semi-crystalline form. The ability of a PET container to maintain its material integrity relates to the percentage of the PET container in crystalline form, also known as the “crystallinity” of the PET container. The following equation defines the percentage of crystallinity as a volume fraction:

$$\\ \% Crystallinity = ( \frac{ρ - {ρ}_{a}}{{ρ}_{c} - {ρ}_{a}} ) \times 100$$

where ρ is the density of the PET material; ρa is the density of pure amorphous PET material (1.333 g/cc); and pc is the density of pure crystalline material (1.455 g/cc).

Container manufacturers use mechanical processing and thermal processing to increase the PET polymer crystallinity of a container. Mechanical processing involves orienting the amorphous material to achieve strain hardening. This processing commonly involves stretching an injection molded PET preform along a longitudinal axis and expanding the PET preform along a transverse or radial axis to form a PET container. The combination promotes what manufacturers define as biaxial orientation of the molecular structure in the container. Manufacturers of PET containers currently use mechanical processing to produce PET containers having approximately 20% crystallinity in the container's sidewall.

Thermal processing involves heating the material (either amorphous or semi-crystalline) to promote crystal growth. On amorphous material, thermal processing of PET material results in a spherulitic morphology that interferes with the transmission of light. In other words, the resulting crystalline material is opaque, and thus, generally undesirable. Used after mechanical processing, however, thermal processing results in higher crystallinity and excellent clarity for those portions of the container having biaxial molecular orientation. The thermal processing of an oriented PET container, which is known as heat setting, typically includes blow molding a PET preform against a mold heated to a temperature of approximately 250° F.-350° F. (approximately 121° C.-177° C.), and holding the blown container against the heated mold for approximately two (2) to five (5) seconds. Manufacturers of PET juice bottles, which must be hot-filled at approximately 185° F. (85° C.), currently use heat setting to produce PET bottles having an overall crystallinity in the range of approximately 25%-35%.

While existing containers are suitable for their intended use, they are subject to improvement. For example, for cold-fill, dairy, coffee-based drinks, and aseptic containers, it would be desirable to have a container that enables some vacuum absorption, is low profile, and is functional. The containers of the present disclosure advantageously provide such features, as well as numerous others as described herein and as one skilled in the art will appreciate.

Further areas of applicability will become apparent from the description provided herein. The description and specific examples in this summary are intended for purposes of illustration only and are not intended to limit the scope of the present disclosure.

### SUMMARY

This section provides a general summary of the disclosure, and is not a comprehensive disclosure of its full scope or all of its features.

The present disclosure includes a polymeric container having a finish defining an opening of the container. A body of the container defines a portion of an internal volume of the container and includes a sidewall. A base of the container includes a pushup portion at an axial center of the base and an outer standing surface. A plurality of straps are spaced apart about the outer standing surface. A diaphragm extends from the outer standing surface to the pushup portion.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of select embodiments and not all possible implementations, and are not intended to limit the scope of the present disclosure.

FIG. 1 is a side view of a container in accordance with the present disclosure;

FIG. 2 is a perspective view of the container of FIG. 1 showing a base thereof;

FIG. 3 is a plan view of the base of the container;

FIG. 4 is a cross-sectional view taken along line 4-4 of FIG. 3;

FIG. 5 is a cross-sectional view of the base in an as-blown configuration; and

FIG. 6 is a cross-sectional view of the base in a post-fill, post-vacuum configuration.

Corresponding reference numerals indicate corresponding parts throughout the several views of the drawings.

### DETAILED DESCRIPTION

Example embodiments will now be described more fully with reference to the accompanying drawings.

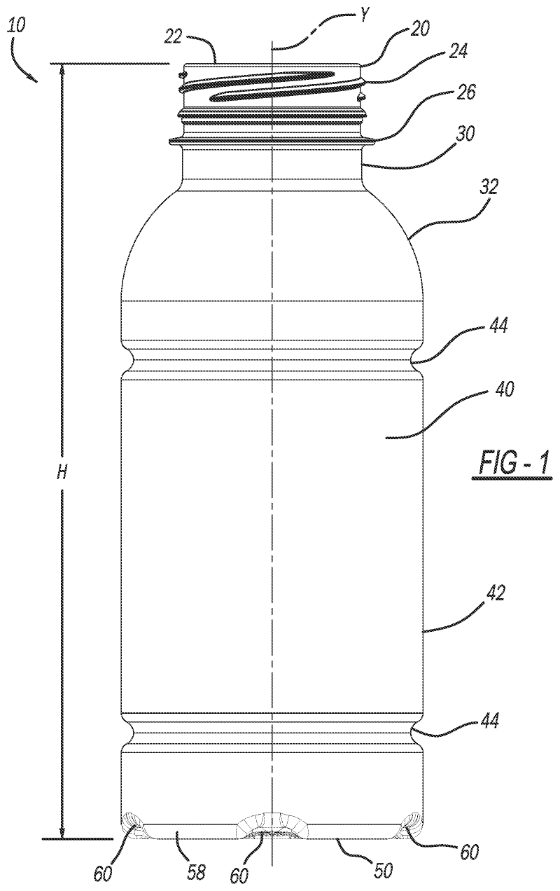

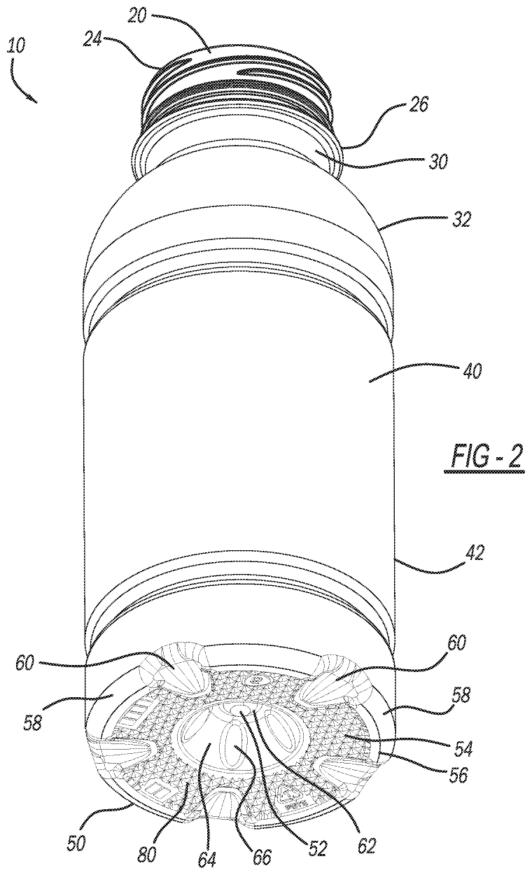

With initial reference to FIGS. 1 and 2, an exemplary polymeric container in accordance with the present disclosure is illustrated at reference numeral 10. The container 10 may have any suitable size and shape, in addition to the shape illustrated. The container 10 can be configured to store any suitable product, such as, but not limited to dairy, coffee, water, juice, carbonated soda, etc.

An example of a material that the container 10 may be made of is polyethylene terephthalate (PET) resin. DAK Americas HS Ti818 is an example of a suitable PET resin. PET is a clear, strong, and lightweight plastic that is widely used for packaging foods and beverages, convenience-sized soft drinks, juices and water. It is also popular for packaging salad dressings, peanut butter, cooking oils, mouthwash, shampoo, soaps, cleaners, and the like. The basic building blocks of PET are ethylene glycol and terephthalic acid, which are combined to form a polymer chain. The resulting spaghetti-like strands of PET are extruded, quickly cooled, and cut into small pellets. The resin pellets are then heated to a molten liquid that can be easily extruded or molded into items of practically any shape. PET is completely recyclable, and is the most recycled plastic in the U.S. and worldwide. PET can be commercially recycled by thorough washing and re-melting, or by chemically breaking it down to its component materials to make new PET resin. Almost every municipal recycling program in North America and Europe accepts PET containers. Products commonly made from recycled PET include new PET bottles and jars. Recycled PET is commonly referred to as rPET and PCR.

The container 10 may be made of any other suitable polymeric material, such as any suitable high-density polyethylene (HDPE). High-density polyethylene is a thermoplastic polymer produced from the monomer ethylene. With a high strength-to-density ratio, HDPE is used in the production of plastic bottles. HDPE is commonly recycled, and has the number “2” as its resin identification code. HDPE is known for its high strength-to-density ratio. The density of HDPE can range from 930 to 970 kg/m³. Although the density of HDPE is only marginally higher than that of low-density polyethylene, HDPE has little branching, giving it stronger intermolecular forces and tensile strength (38 MPa versus 21 MPa) than LDPE. The difference in strength exceeds the difference in density, giving HDPE a higher specific strength. It is also harder and more opaque and can withstand somewhat higher temperatures (120° C./248° F. for short periods).

The container 10 may be made of up to 100% recycled material such as PCR or PIR material. Post-consumer recycled (PCR) resin is the recycled product of waste created by consumers. Post Industrial Regrind (PIR) is any closed-loop/recaptured scrap resin directly resulting from the manufacturing process such as the scrap created by the manufacturing process of bottles and closures that is solely recaptured and reworked within the manufacturing plant such as hot-runners, flash, moils, and tails from the molding or extruding process that has gone through at least one molding or extrusion process and is subsequently grounded and reintroduced back into the manufacturing process. Since PCR/PIR regrind material has gone through an initial heat and molding process it cannot be considered “virgin” material. The physical, chemical and flow properties can differ slightly from virgin material, therefore PCR and PIR is not generally used exclusively to make new bottles or parts, but it is blended with virgin PET. Before PCR and PIR plastic is turned into resin, the materials are sent through a proprietary process and cleaning to produce plastic resin pellets. Verdeco food-grade rPET is an example of a suitable resin.

The container 10 may be formed by any suitable process. For example, the container 10 may be made by one-step or two-step injection stretch blow molding (ISBM). The container 10 may also be made by extrusion blow molding (EMB).

Injection stretch blow molding includes using a pre-made injection molded preform that is optimized for the final blow molded container 10. The injection molded preform is reheated and placed in a blow mold where it is stretched lengthwise (axial stretch) to about twice its original length. Compressed air is then blown into the stretched preform to expand to the blow mold (radial stretch) forming the final shape of the container.

With extrusion blow molding (EBM), the polymeric material is melted and extruded into a hollow tube called a parison. This parison is then captured by closing it into a metal mold. Air is then blown into the parison, inflating it into the shape of the bottle. With EBM there is no axial stretching of the HDPE material as it is blown into the final container shape.

The container 10 generally includes a finish 20 defining an opening 22 of the container 10. The opening 22 provides access to an interior volume of the container 10. At an exterior of the finish 20 are threads 24, which are configured to cooperate with any suitable closure for closing the opening 22. The threads 24 are illustrated as external threads, but the threads 24 may be internal threads or configured in any other suitable manner. Below the threads 24 is a flange 26, which is used to support the preform during the blow molding process.

Below the flange 26 is a neck 30, and below the neck 30 is a shoulder 32. The shoulder 32 extends to a body 40, which defines a majority of the internal volume. The body 40 includes a sidewall 42, which may be cylindrical as illustrated or have any other suitable shape. The sidewall 42 may define ribs 44, which extend about a circumference of the sidewall 42. The ribs 44 may have any suitable shape and size configured to facilitate absorption of vacuum.

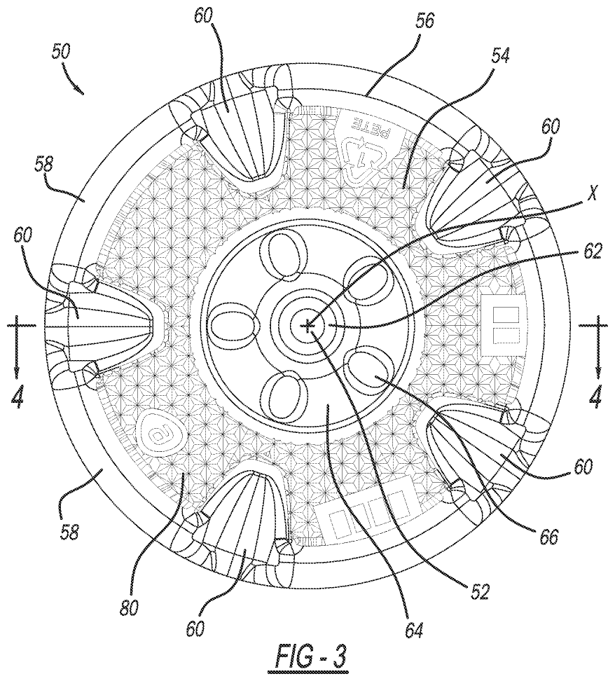

At a bottom of the container 10 is a base 50. With continued reference to FIGS. 1 and 2, and additional reference to FIGS. 3-6, the base 50 will now be described in detail. The base 50 includes a center pushup portion 52 at an axial center X of the base 50. A longitudinal axis Y of the container 10 extends through the axial center X of the base 50, as well as an axial center of the opening 22. A diaphragm 54 extends outward from the center pushup portion 52 to an outer standing surface 56. The outer standing surface 56 is at an outer perimeter of the base 50 and is configured to support the container 10 upright on a planar, or generally planar, surface. Spaced apart about the base 50 are a plurality of straps 60. A heel 58 extends from the outer standing surface 56 to the sidewall 42. The various features of the base 50 are described in detail below.

The center pushup portion 52 includes a center portion 62 through which the longitudinal axis Y extends. The center portion 62 is in a plane extending perpendicular to the longitudinal axis Y. Extending outward from the center portion 62 is an angled portion 64 to give the center pushup portion 52 a truncated cone shape in cross-section.

The center pushup portion 52 further includes a plurality of protrusions 66, each one of which is aligned with a different one of the plurality of straps 60. The protrusions 66 protrude outward from the angled portion 64 towards the longitudinal axis. The protrusions 66 are configured as stiffening portions.

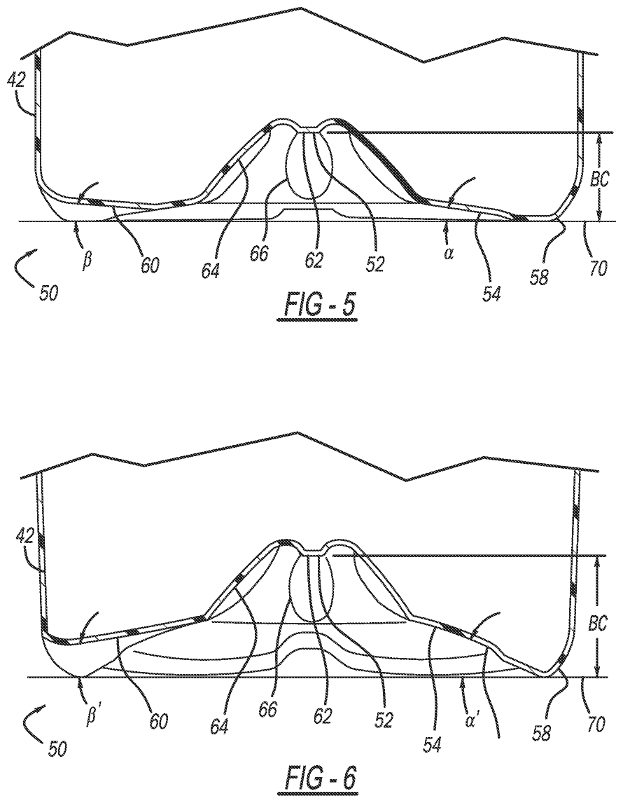

The pushup portion 52 is the most rigid part of the base 50 and generally retains its shape as the pushup portion 52 moves from the as-blown configuration of FIG. 5 to the post-fill, post-vacuum configuration of FIG. 6. More specifically, from the as-blown configuration of FIG. 5, the pushup portion 52 moves inward along the longitudinal axis Y towards the opening 22 to the post-fill, post-vacuum configuration of FIG. 6 in response to a vacuum within the container 10 generated during filling and capping. In the post-fill, post vacuum configuration of FIG. 6, the center pushup portion 52 has a base clearance BC (FIG. 6) of 5% to 6% (or about 5% to about 6%) of an overall height H (FIG. 1) of the container 10. The base clearance BC is measured from the outer standing surface 56 (and a base surface 70 upon which outer standing surface 56 is seated) vertically to the center portion 62 of the center pushup portion 52. The following are exemplary dimensions of various examples of the container 10:

| | Base | Container | |
|---|---|---|---|
| Container # | Clearance | Height | % |
| 1 | 0.617 | 9.963 | 6% |
| 2 | 0.567 | 9.564 | 6% |
| 3 | 0.335 | 5.252 | 6% |
| 4 | 0.335 | 5.83 | 6% |
| 5 | 0.335 | 6.22 | 5% |
| 6 | 0.335 | 6.304 | 5% |

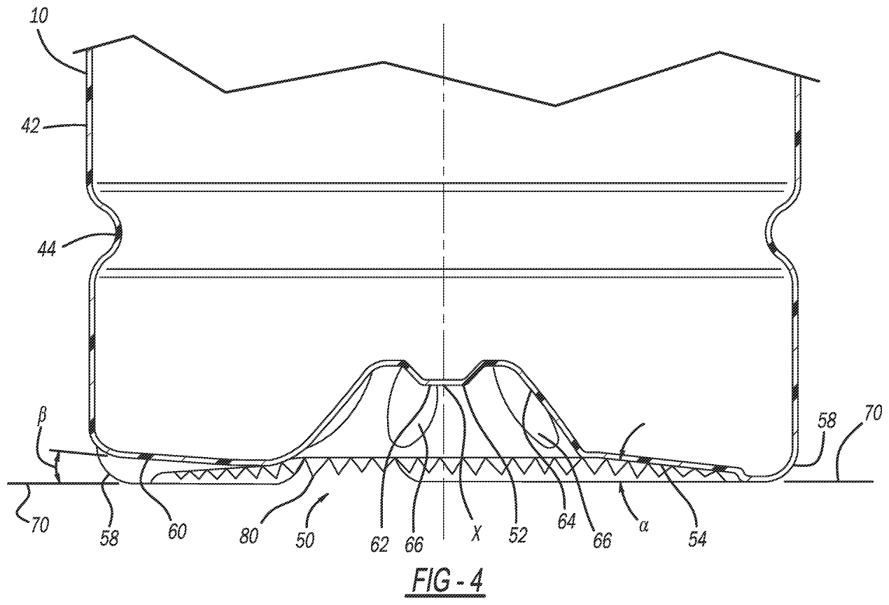

The diaphragm 54 is generally round and has a shallow inset from the outer standing surface 56 (and a surface 70 upon which outer standing surface 56 is seated) of 1-5 mm. The diaphragm 54 extends from the outer standing surface 56 to an outer diameter of the center pushup portion 52 at an upward angle, which is illustrated at diaphragm angle α in the as-blown configuration in FIGS. 4 and 5, and at diaphragm angle α′ in the post-fill configuration of FIG. 6. The diaphragm 54 is interrupted by the straps 60 at the outer perimeter thereof. The diaphragm angle α may be any suitable angle, such as 5.25° as-blown. The diaphragm 54 is straight as viewed from the side cross-section in the as-blown configuration (FIG. 5, for example), and becomes concave in response to vacuum in the container 10 (FIG. 6, for example).

The diaphragm 54 may include a textured surface 80. Any suitable textured surface 80 may be included that is configured to facilitate flexing of the diaphragm 54 in response to pressure change within the container 10. For example, the textured surface 70 may include triangular-shaped features as illustrated.

Each one of the plurality of straps 60 has a truncated oval shape in cross-section. The plurality of straps 60 are evenly spaced apart about the base 50 in a polar array around the axial center X of the base 50. The straps 60 also interrupt the heel 58. When viewed from a side of the container 10, the straps 60 are also shaped like truncated ovals that interrupt the standing surface 56 and the heel 58. Any suitable number of straps 60 may be included, such as 3-7 straps, and particularly 5 straps 60. In the as-blown configuration of FIGS. 4 and 5, each one of the plurality of straps 60 extend at a strap angle β relative to the standing surface 56 and the surface 70 upon which the container 10 is seated. The strap angle β may be any suitable angle, such as 4 to 8 degrees. In the post-fill, post-vacuum configuration of FIG. 6, the strap angle β′ may be any suitable angle, such as −4° to −8° degrees. The straps 60 advantageously stabilize the base 50, the heel, 58, and the standing surface 56 to prevent undesirable deformation under an increase in vacuum forces. A radius of the heel 58 increases as vacuum in the container increases and the center pushup portion 52 moves inward towards the finish 20 as heel 58 moves from the as-blown position of FIG. 5 to the post-fill, post-vacuum position of FIG. 6.

The base 50 is configured such that: the plurality of straps 60 have a combined surface area that is 21%-32% of a total surface area of the base 50; the diaphragm 54 makes up 38%-46% of the total surface area of the base 50; the center pushup portion 52 is 20%-29% of the total surface area of the base 50; and the outer standing surface (i.e., standing ring) 56 is 6%-13% of the total surface area of the base 50. The following table includes additional exemplary dimensions for the containers 10 in accordance with the present disclosure (containers #1-#6 are additional dimensions for the above-referenced containers #1-6, all of which are exemplary containers 10 in accordance with the present disclosure):

| | | | | | Base Insert | | | | | Strap | Diaphragm |
|---|---|---|---|---|---|---|---|---|---|---|---|
| Container | Strap (cm²) | | Diaphragm(cm²) | | (cm²) | | | Standing | | Angle | Angle |
| # | % | Actual | % | Actual | % | Actual | % | ring(cm²) | Total | (deg) | (deg) |
| 1 | 21% | 15.583 | 40% | 29.336 | 25% | 18.138 | 13% | 9.697 | 72.754 | 4 | 5.25 |
| 2 | 19% | 16.283 | 43% | 36.462 | 26% | 22.226 | 12% | 10.464 | 85.435 | 4 | 5.25 |
| 3 | 32% | 13.57 | 43% | 18.153 | 20% | 8.588 | 5% | 2.267 | 42.578 | 8 | 5.25 |
| 4 | 24% | 8.877 | 46% | 17.093 | 24% | 8.696 | 6% | 2.24 | 36.906 | 5 | 5.25 |
| 5 | 24% | 8.877 | 46% | 17.093 | 24% | 8.696 | 6% | 2.24 | 36.906 | 5 | 5.25 |
| 6 | 27% | 8.247 | 38% | 11.471 | 29% | 8.834 | 7% | 1.995 | 30.547 | 8 | 5.25 |

The container 10 may be filled in any suitable manner, such as by way of a hot-fill or cold-fill process, for storing any suitable product. For example, the container 10 may be filled with an aseptic filling process. With respect to aseptic filling, it allows for food to be sterilized outside the container 10 and then placed into a previously sterilized container, which is then sealed in a sterile environment. Most aseptic filling systems use ultra-high temperature (UHT) sterilization to sterilize the food product before it is packaged. UHT sterilizes food at high temperatures usually above 135° C. for 1-2 seconds. This is advantageous because it allows for faster processing, usually a few seconds at high temperatures and better retention of sensory and nutritional characteristics. Aseptic products have a non-refrigerated shelf-life of a few months to several years. The containers are sterilized to kill microorganisms present on the container during forming and transport and prior to filling. The most commonly used methods include: heat, hot water, chemical (hydrogen peroxide or peracetic acid), and radiation. Aseptically processed food products can be sterilized using either direct or indirect methods of heat transfer. Direct heat transfer can be achieved through steam injection and steam infusion. Indirect forms of heat transfer include: plate heat exchangers, tubular heat exchangers, or scraped-surface heat exchangers.

The container 10 may also be filled by any suitable hot-fill process. Hot filling is a process where the product is heated to a high temperature, such as 194° F. for example or higher, to remove harmful bacteria or microorganisms that might be present with the product. Then the hot fluid is filled into the container 10 and the container 10 is capped.

The container 10 may also be cold-filled. During the cold fill process the container is pressurized by cooling the product when the cold product is added to the cold container. The cold fill process requires sterilization of the container, which can be either a wet or dry sterilization.

The present disclosure thus advantageously provides for a container 10 with a relatively shallow base 50 for round containers that flexes under changes in internal vacuum caused by heating and cooling of the internal liquid product. The base 50 includes a plurality of rigid straps 60 around the standing surface 56, heel 58, and diaphragm 54. Other advantages of the container 10 include improved material distribution and elimination of base sag on hotfill, coldfill, and aseptic applications when using up to 100% recycled material.

The low profile base strap 60 and diaphragm 54 enables movement in the base 50 to accommodate vacuum. It is of value to customers in the coldfill/dairy/aseptic space looking for something that enables low vacuum applications caused by up to a 4% volume reduction within the container 10 to perform without uncontrolled sidewall deformation. It's common that hot-fill products require technology that reduces vacuum caused when the product cools. Vacuum can also occur for some cold-fill products, such as coffee. The coffee absorbs oxygen out of the headspace of the filled container and causes denting and deformation of the container.

The combination of the surface area of the straps 60 and textured surface 80 of the diaphragm 54 create flexibility for movement under vacuum, which creates a controlled mode of movement in the base 50 of the container. The straps 60 and textured surface 80 work in tandem to flex upwards into the cavity of the container 10 as vacuum increases.

Customers in the coldfill/dairy/aseptic space are generally interested in vacuum solutions that enable some vacuum absorption. Premium brands are looking for a solution that is low profile and functional. The present disclosure addresses and solves these long-felt needs. The base 50 can be applied to a container without the need of blow mold process aid from overstroke or counterstretch during blow molding. Overstroke is a complex moving mechanical activation unit on a blow molder used to form deep base geometry, which in view of the present disclosure is not needed due to the configuration of the shallow base 50, which advantageously saves on tooling costs. Counterstretch is a process of keeping the preform centered during blow molding to ensure consistency of material distribution.

The present disclosure also provides improved vacuum performance, ease of manufacture, controlled vacuum response by way of the straps 60 and the surface area of textured base geometry. The container 10 is configured for being sterilized for aseptic/ESL applications, and the container's lower profile strap geometry can be used with Peracetic acid and hydrogen peroxide sterilization.

The base of a container is typically the hardest area to maintain a high level of stretch induced crystallinity. Due to the blow molding process, the base area is more amorphous. Therefore, it is advantageous to have a higher level of crystallinity to enhance resistance to thermal stress caused by hot-filling the container 10 with liquid product. Lower crystallinity allows the base to be softened by the hot-fill process and to move down under the weight of the product in the container. This is typically called base roll out, base drop, or base sag.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A polymeric container comprising:
a finish defining an opening of the container;
a body defining a portion of an internal volume of the container, the body including a sidewall; and
a base including:
a pushup portion at an axial center of the base;
an outer standing surface;
a heel extending from the outer standing surface to the sidewall;
a plurality of straps spaced apart about the outer standing surface; and
a diaphragm extending from the outer standing surface to the pushup portion;
wherein:
the base moves inward toward the finish from an as-blown configuration to a post-fill, post vacuum configuration after the container has been filled and capped to generate a vacuum therein;
in the as-blown configuration the diaphragm is linear in cross-section;
in the post-fill, post-vacuum configuration the diaphragm is concave relative to an outer surface of the base; and
as the base moves inward from the as-blown configuration to the post-fill, post vacuum configuration, an angle of intersection between the outer standing surface and the heel decreases as vacuum in the container increases and the pushup portion moves inward towards the finish.

2. The polymeric container of claim 1, wherein the polymeric container is made of polyethylene terephthalate (PET).

3. The polymeric container of claim 1, wherein the polymeric container is made of high-density polyethylene (HDPE).

4. The polymeric container of claim 1, wherein the polymeric container includes up to 100% recycled material.

5. The polymeric container of claim 1, wherein the diaphragm includes an outer textured surface.

6. The polymeric container of claim 5, wherein the outer textured surface includes a triangle-shaped texture.

7. The polymeric container of claim 1, wherein the diaphragm is interrupted by the plurality of straps at an outer circumference of the diaphragm.

8. The polymeric container of claim 1, wherein in the as-blown configuration, the diaphragm is angled inward at 5.25°.

9. The polymeric container of claim 1, wherein the diaphragm has a shallow inset from the heel of 1 mm to 5 mm.

10. The polymeric container of claim 1, wherein a radius of the heel increases as vacuum in the container increases and the pushup portion moves inward towards the finish.

11. The polymeric container of claim 1, wherein the container is configured to undergo a 4% reduction in the internal volume after being cold-filled with a product.

12. The polymeric container of claim 1, wherein each one of the plurality of straps has a truncated oval shape.

13. The polymeric container of claim 1, wherein the plurality of straps consists of five straps.

14. The polymeric container of claim 1, wherein each one of the plurality of straps extends outward from the diaphragm to a heel of the polymeric container at an angle of from 4° to 8° in the as-blown configuration.

15. The polymeric container of claim 1, wherein in the post-fill, post-vacuum configuration each one of the plurality of straps extends outward from the diaphragm to the heel of the polymeric container at an angle of from −4° to −8°.

16. The polymeric container of claim 1, wherein the plurality of straps interrupt the heel around a circumference of the heel.

17. The polymeric container of claim 1, wherein the pushup portion is configured as a truncated cone when viewed in cross-section.

18. The polymeric container of claim 1, wherein the pushup portion includes a plurality of protrusions; and
wherein each one of the plurality of protrusions is aligned with one of the plurality of straps.

19. The polymeric container of claim 18, wherein the base includes an equal number of the plurality of protrusions and the plurality of straps.

20. The polymeric container of claim 1, wherein an innermost part of the pushup portion is recessed inward from the outer standing surface towards the finish at a clearance of 5% to 6% of an overall height of the polymeric container.

21. The polymeric container of claim 1, wherein the pushup portion has a rigidity that is greater than a remainder of the base.

22. The polymeric container of claim 1, wherein the plurality of straps have a strap surface area that is 21%-32% of a total base surface area of the base.

23. The polymeric container of claim 1, wherein the diaphragm has a diaphragm surface area that is 38%-46% of a total base surface area of the base.

24. The polymeric container of claim 1, wherein the pushup portion has a pushup surface area that is 20%-29% of a total base surface area of the base.

25. The polymeric container of claim 1, wherein the standing ring has a ring surface area that is 6%-13% of a total base surface area of the base.

26. The polymeric container of claim 1, wherein the base is circular.
